(19) United States
(12) Patent Application Publication
(10) Pub. No.: US 2021/0325221 A1
(43) Pub. Date: Oct. 21, 2021

(54) Coriolis Mass Flow Sensor

(71) Applicant: Guanghua WU, McKinney, TX (US)

(72) Inventor: Guanghua WU, McKinney, TX (US)

(21) Appl. No.: 16/852,760

(22) Filed: Apr. 20, 2020

(51) Int. Cl. G01F 1/84

(52) U.S. Cl. CPC G01F 1/8436; G01F 1/8427; G01F 1/8404; G01F 1/8431

(57) ABSTRACT

A Coriolis mass flow sensor uses a multiple-loops form of sensing tube and combined it with a middle post. The resulted sensing tube has high swing stiffness and low twist stiffness and this increases the sensitivity of the sensor tremendously.

### FIELD OF THE INVENTION

The present invention is related to a Coriolis mass flow sensor with a specially bent and constructed sensing tube to improve the sensor's sensitivity.

### BACKGROUND OF THE INVENTION

Coriolis mass flow sensor utilizes Coriolis effect to measure the mass flow rate. When a mass moves in a rotating reference-frame, a force called Coriolis force (named after Gaspard-Gustave de Coriolis, a French scientist, 1792-1843) will occur, which can be expressed as

F_{c}=m(−2ω×vᵣ), (1)

where
F_{c} is the Coriolis force vector;
m is the mass of the object;
ω is the angular frequency vector of the rotating reference-frame;
vᵣ is the velocity of the mass relative to the rotating reference-frame.
The direction of Coriolis force is perpendicular to both the rotating axis of the reference-frame and the relative velocity of the mass and it can be decided by the right-hand rule, that is with the right thumb pointing along the rotation direction, the index finger pointing along the flow direction, the direction of the Coriolis force will be the negative direction of the middle finger.

The Coriolis effect can be explained by a sensor with a U-shaped sensing tube as shown in FIG. 1. The tube is fixed at two ends C and C′. Fluid flows in from C end and flows out from C′ end. A permanent magnet disk is attached to the middle of the top transverse beam of the tube at location A, and a coil at the side of it (not shown) is driven by a sinusoidal current, and the magnetic force between the coil and the magnet disk causes the tube to vibrate at a frequency f and the angular frequency is ω=2πf. The angular frequency of the rotation-frame ω is also the resonant angular frequency of the tube, otherwise, it will take too much power to maintain a vibration with a measurable amplitude. Without flow, the tube will act back and forth doing a swing motion.

Once there is a flow existing in the tube, the Coriolis force F_{c} will be produced as shown in FIG. 1. The Coriolis forces on the two lateral beams will twist the tube around z-axis. As for the transverse beam of the tube, as the flow is parallel to the rotation axis, x-axis, there will be no Coriolis force.

As ω is changing direction and magnitude all the time, so is the Coriolis force. The twist motion of the tube is a forced oscillation, its frequency is the same as the excitation frequency, even the tube has its own twist resonant frequency, which is generally higher than the swing resonant frequency.

In FIG. 1, Position \textcircled{1} is the position when the tube is at its rest, Position \textcircled{2} is the position where the tube is moving away from its rest position \textcircled{1} without the twist motion, and Position \textcircled{3} is the position where both the swing and the twist motions exist.

Two optical sensors are placed at B and B′ locations (not shown) to monitor the movement of the tube, the circuit will filter out the swing motion, and the twist motion left will be used as an indication of the mass flow rate. In practice, the phase difference between the inlet leg and the outlet leg will be measured.

As the mass in the tube is a continuous flow, the total Coriolis force can be obtained by integrating Equation (1) along the legs of the tube as

F_{c}=∫ₗ₌₀^{l=H}−2(ω×vᵣ)·ρ·A·dl, (2)

where
H is the length of the inlet or outlet leg;
ρ is the density of the fluid;
A is the section area of the measuring tube;
dl is an infinitesimal piece of the tube.

In Eq. (2), the m in Eq. (1) is replaced by ρ·A·dl, a glob of the fluid. Notice that vᵣ·ρ·A is the mass flow rate \dot{m}, Equation (2) can be rewritten as

F_{c}=∫ₗ₌₀^{l=H}−2(ω×\dot{m})·dl=−2H·(ω×\dot{m}). (3)

It is a uniformly distributed force on the inlet leg and the outlet leg.

We can use the following equation to describe the swing motion of the tube:

θ(t)=θₘₐₓ·sin(ωt), (4)

where θ(t), and θₘₐₓ are the swing angle as a function of time and the maximum swing angle of the swing motion, respectively (we let the initial angle to be zero and this will not influence the analysis results). For the swing motion of the U-shaped tube, the angular frequency ω is no longer a constant as the reference frame of a fixed axis rotation disk. The angular frequency is changing the magnitude and velocity all the time. When the tube passes its rest location, the angular frequency is at its maximum and when the amplitude reaches to its maximum, the angular frequency is zero. Also, this angular frequency is changing the direction periodically. As we mentioned before, during the measuring, the frequency of the swing motion is the same as the swing resonant frequency of the tube, that is ω=ω_{θ}, and the angular frequency ω of the swing motion in Eq. (3) can be obtained by differentiating θ(t) of Eq. (4)

$$\vert ω \vert = \frac{d θ ( t )}{dt} = {θ}_{max} {ω}_{θ} \cdot cos ( {ω}_{θ} t ) , \qquad ( 5 )$$

and from Eq. (3) we have

$${F}_{c} = \vert {F}_{c} \vert = 2 H \dot{m} \frac{d θ ( t )}{dt} = 2 H \dot{m} {θ}_{max} {ω}_{θ} \cdot cos ( {ω}_{θ} t ) . \qquad ( 6 )$$

For the twist motion caused by the Coriolis force, it is a forced vibration around z axis under the excitation of the Coriolis force. The differential equation of this motion is

$${I}_{ϕ} \frac{{d}^{2} ϕ}{{dt}^{2}} + {c}_{φ} \frac{d ϕ}{dt} + {k}_{ϕ} ϕ = {T}_{ϕ} , \qquad ( 7 )$$

where
I_{Ø} is the mass moment of inertia around z-axis;
c_{Ø} is the coefficient of viscous damping of the twist motion, it is proportional to the angular velocity

$$\frac{d ϕ}{dt} ,$$

and resisting the motion;
k_{Ø} is the twist spring constant of the U-shaped tube,

$${k}_{ϕ} = \frac{{T}_{ϕ}}{ϕ} ,$$

### [N·m/rad];

T_{Ø} is the torque around z-axis, and T_{Ø}=F_{c}W,

where

W—the width of the U-shaped tube.

Eq. (7) then becomes

$${I}_{ϕ} \frac{{d}^{2} ϕ}{{dt}^{2}} + {c}_{ϕ} \frac{d ϕ}{dt} + {k}_{ϕ} ϕ = 2 H \dot{m} {θ}_{max} {ω}_{θ} W \cdot cos ( {ω}_{θ} t ) . \qquad ( 8 )$$

The solution of Eq. (8) is

$$ϕ ( t ) = \frac{2 H \dot{m} {θ}_{max} {ω}_{θ}^{2} W {c}_{φ}}{{( {k}_{ϕ} - {I}_{ϕ} {ω}_{θ}^{2} )}^{2} + {( {c}_{ϕ} {ω}_{θ} )}^{2}} \cdot sin ( {ω}_{θ} t ) + \frac{2 H \dot{m} {θ}_{max} {ω}_{θ} W ( {k}_{ϕ} - {I}_{ϕ} {ω}_{θ}^{2} )}{{( {k}_{ϕ} - {I}_{ϕ} {ω}_{θ}^{2} )}^{2} + {( {c}_{ϕ} {ω}_{θ} )}^{2}} \cdot cos ( {ω}_{θ} t ) . \qquad ( 9 )$$

Eq. (9) can be written as

Ø(t)=Øₘₐₓ·cos(ω_{θ}t−α), (10)

where Øₘₐₓ is the maximum amplitude of Ø(t).

By using triangle formula, Eq. (10) can be written as

Ø(t)=Øₘₐₓ·(sin(α)sin(ω_{θ}t)+cos(α)cos(ω_{θ}t)). (11)

Compare Eq. (9) with Eq. (11), we have

$$\begin{matrix}{ϕ}_{max} \cdot sin ( α ) = \frac{2 H \dot{m} {θ}_{max} {ω}_{θ}^{2} W {c}_{ϕ}}{{( {k}_{ϕ} - {I}_{ϕ} {ω}_{θ}^{2} )}^{2} + {( {c}_{ϕ} {ω}_{θ} )}^{2}} , \\ and & ( 12 ) \\ {ϕ}_{max} \cdot cos ( α ) = \frac{2 H \dot{m} {θ}_{max} {ω}_{θ} W {k}_{ϕ} ( 1 - \frac{{ω}_{θ}^{2}}{{ω}_{ϕ}^{2}} )}{{( {k}_{ϕ} - {I}_{ϕ} {ω}_{θ}^{2} )}^{2} + {( {c}_{ϕ} {ω}_{θ} )}^{2}} . & ( 13 )\end{matrix}$$

Add the square of Eq. (12) and the square of Eq. (13), by manipulation, we have

$${ϕ}_{max} = \frac{2 H \dot{m} {θ}_{max} W {ω}_{θ}}{\sqrt{{{k}_{ϕ}^{2} ( 1 - \frac{{ω}_{θ}^{2}}{{ω}_{ϕ}^{2}} )}^{2} + {( {c}_{ϕ} {ω}_{θ} )}^{2}}} . \qquad ( 14 )$$

In the process, the relationship

$${ω}_{ϕ} = \sqrt{\frac{{k}_{ϕ}}{{I}_{ϕ}}} \qquad ( 15 )$$

is used, where ω_{Ø} is the twist resonant angular frequency of the tube.

Divided Eq. (12) by Eq. (13) we have

$$α = atan ( \frac{{c}_{ϕ} {ω}_{θ}}{{k}_{ϕ} ( 1 - \frac{{ω}_{θ}^{2}}{{ω}_{ϕ}^{2}} )} ) . \qquad ( 16 )$$

α is usually a very small (<0.01°) phase delay angle.

For later use and from Eq. (13) and Eq. (14), we have

$$cos ( α ) = \frac{{k}_{ϕ} ( 1 - \frac{{ω}_{θ}^{2}}{{ω}_{ϕ}^{2}} )}{\sqrt{{{k}_{ϕ}^{2} ( 1 - \frac{{ω}_{θ}^{2}}{{ω}_{ϕ}^{2}} )}^{2} + {( {c}_{ϕ} {ω}_{θ} )}^{2}}} . \qquad ( 17 )$$

Plug Eq. (14) back into Eq. (10), we have

$$ϕ ( t ) = \frac{2 H \dot{m} {θ}_{max} W {ω}_{θ}}{{{k}_{ϕ}^{2} ( 1 - \frac{{ω}_{θ}^{2}}{{ω}_{ϕ}^{2}} )}^{2} + {( {c}_{ϕ} {ω}_{θ} )}^{2}} \cdot cos ( {ω}_{θ} t - α ) . \qquad ( 18 )$$

As we mentioned before, during measuring, the excitation frequency is the same as the swing resonant frequency of the tube, that is ω=ω_{θ}, then Eq. (4) becomes

θ(t)=θₘₐₓ·sin(ω_{θ}t). (19)

Compare Eq. (19) with Eq. (18), we can see that the phase difference between these two motions is

$$( \frac{π}{2} - α ) ,$$

and these two functions are plotted in FIG. 2. The swing motion is

$$( \frac{π}{2} - α )$$

ahead of the twist motion, the α angle in the plot is exaggerated and the amplitudes are assumed.

We want to find out the phase relationship between B point of the inlet leg (optical sensor location) and B′ point of the outlet leg (another optical sensor location). At the measurement point B, we assign d_{α}, d_{Ø}, and d_{θ} as the absolute, the relative and the reference amplitude vectors, respectively. From superposition principle, we have

d_{α}=d_{Ø}+d_{θ}. (20)

From Eq. (14) and the geometrical relations, we have

$$\begin{matrix}\vert {d}_{ϕ} \vert = \frac{W}{2} \cdot \frac{{H}^{′}}{H} {ϕ}_{max} \\ = \frac{W}{2} \cdot \frac{{H}^{′}}{H} \frac{2 H \dot{m} {θ}_{max} W {ω}_{θ}}{\sqrt{{{k}_{ϕ}^{2} ( 1 - \frac{{ω}_{θ}^{2}}{{ω}_{ϕ}^{2}} )}^{2} + {( {c}_{ϕ} {ω}_{θ} )}^{2}}} \\ = \frac{{θ}_{max} \dot{m} {H}^{′} {W}^{2} {ω}_{θ}}{\sqrt{{{k}_{ϕ}^{2} ( 1 - \frac{{ω}_{θ}^{2}}{{ω}_{ϕ}^{2}} )}^{2} + {( {c}_{ϕ} {ω}_{θ} )}^{2}}} .\end{matrix} \qquad ( 21 )$$

From Eq. (19) and the geometrical relation, we have

|d_{θ}|=H′θₘₐₓ. (22)

Substitute Eq. (21) and Eq. (22) into Eq. (20), we have

$$\begin{matrix}\vert {d}_{a} \vert = \sqrt{{( \frac{{θ}_{max} \dot{m} {H}^{′} {W}^{2} {ω}_{θ}}{\sqrt{{{k}_{ϕ}^{2} ( 1 - \frac{{ω}_{θ}^{2}}{{ω}_{ϕ}^{2}} )}^{2} + {( {c}_{ϕ} {ω}_{θ} )}^{2}}} )}^{2} + {( {H}^{′} {θ}_{max} )}^{2}} \\ = {H}^{′} {θ}_{max} \sqrt{{( \frac{\dot{m} {W}^{2} {ω}_{θ} {ω}_{θ}}{\sqrt{{{k}_{ϕ}^{2} ( 1 - \frac{{ω}_{θ}^{2}}{{ω}_{ϕ}^{2}} )}^{2} + {( {c}_{ϕ} {ω}_{θ} )}^{2}}} )}^{2} + 1} .\end{matrix} \qquad ( 23 )$$

Geometrically, these three vectors of d_{Ø}, d_{θ} and d_{α} can be depicted as a triangle shown in FIG. 3. In FIG. 3, d′_{Ø} and d′_{θ} are the relative and reference amplitude vectors at B′ point of the outlet leg, respectively. They are symmetrical with d_{Ø}, and d_{θ} respecting to d_{α}. From Eq. (18) and Eq. (19), the phase angle η between d_{Ø} and d_{θ} is

$$( \frac{π}{2} - α ) .$$

What we want to Know is the phase angle difference ψ between d_{Ø} and d′_{Ø}.

From FIG. 3, we have

ψ=π−2B=π−2(π−φ−η)=2φ−2α. (24)

From the law of sines

$$\begin{matrix}\frac{{d}_{a}}{sin ( η )} = \frac{{d}_{ϕ}}{sin ( φ )} = \frac{{d}_{θ}}{sin ( β )} , \\ and with & ( 25 ) \\ sin ( η ) = sin ( \frac{π}{2} - α ) = cos ( α ) , & ( 26 )\end{matrix}$$

Eq. (25) becomes

$$\frac{{d}_{a}}{cos ( α )} = \frac{{d}_{ϕ}}{sin ( φ )} = \frac{{d}_{θ}}{sin ( β )} . \qquad ( 27 )$$

From Eq. (27)

$$sin ( φ ) = \frac{{d}_{ϕ}}{{d}_{a}} cos ( α ) . \qquad ( 28 )$$

Substitute Eqs. (21), (23) and (17) into Eq. (28), we have

$$\begin{matrix}Sin ( φ ) = \frac{\frac{{θ}_{max} \dot{m} {H}^{′} {W}^{2} {ω}_{θ}}{\sqrt{{{k}_{ϕ}^{2} ( 1 - \frac{{ω}_{θ}^{2}}{{ω}_{ϕ}^{2}} )}^{2} + {( {c}_{ϕ} {ω}_{θ} )}^{2}}}}{{H}^{′} {θ}_{max} \sqrt{{( \frac{\dot{m} {W}^{2} {ω}_{θ} {ω}_{θ}}{{{k}_{ϕ}^{2} ( 1 - \frac{{ω}_{θ}^{2}}{{ω}_{ϕ}^{2}} )}^{2} + {( {c}_{ϕ} {ω}_{θ} )}^{2}} )}^{2} + 1}} \frac{{k}_{ϕ} ( 1 - \frac{{ω}_{θ}^{2}}{{ω}_{ϕ}^{2}} )}{\sqrt{{{k}_{ϕ}^{2} ( 1 - \frac{{ω}_{θ}^{2}}{{ω}_{ϕ}^{2}} )}^{2} + {( {c}_{ϕ} {ω}_{θ} )}^{2}}} \\ = \frac{\dot{m} {W}^{2} {ω}_{θ} {k}_{ϕ} ( 1 - \frac{{ω}_{θ}^{2}}{{ω}_{ϕ}^{2}} )}{\sqrt{\{ {[ {k}_{ϕ} ( 1 - \frac{{ω}_{θ}^{2}}{{ω}_{ϕ}^{2}} ) ]}^{2} + {( {c}_{ϕ} {ω}_{θ} )}^{2} \} \{ {( \dot{m} {W}^{2} {ω}_{θ} )}^{2} + {[ {k}_{ϕ} ( 1 - \frac{{ω}_{θ}^{2}}{{ω}_{ϕ}^{2}} ) ]}^{2} + {( {c}_{ϕ} {ω}_{θ} )}^{2} \}}} .\end{matrix} \qquad ( 29 )$$

As φ and α are very small angles, we have sin(φ)≈φ and tan (α)≈α, from Eq. (16), Eq. (24) and Eq. (29), we have

$$ψ = 2 φ - 2 α \\ \approx \frac{( 2 \dot{m} {W}^{2} {ω}_{θ} {k}_{ϕ} ( 1 - \frac{{ω}_{θ}^{2}}{{ω}_{ϕ}^{2}} ) )}{( \sqrt{\{ {[ {k}_{ϕ} ( 1 - \frac{{ω}_{θ}^{2}}{{ω}_{ϕ}^{2}} ) ]}^{2} + {( {c}_{ϕ} {ω}_{θ} )}^{2} \} \{ {( \dot{m} {W}^{2} {ω}_{θ} )}^{2} + {[ {k}_{ϕ} ( 1 - \frac{{ω}_{θ}^{2}}{{ω}_{ϕ}^{2}} ) ]}^{2} + {( {c}_{ϕ} {ω}_{θ} )}^{2} \}} )} - \frac{2 {c}_{ϕ} {ω}_{θ}}{{k}_{ϕ} ( 1 - \frac{{ω}_{θ}^{2}}{{ω}_{ϕ}^{2}} )} . \qquad ( 30 )$$

The solution will be much simpler if we let the phase delay angle α=0 in Eq. (18)

$$ϕ ( t ) = \frac{2 H \dot{m} {θ}_{max} W {ω}_{θ}}{\sqrt{{{k}_{ϕ}^{2} ( 1 - \frac{{ω}_{θ}^{2}}{{ω}_{ϕ}^{2}} )}^{2} + {( {c}_{ϕ} {ω}_{θ} )}^{2}}} \cdot cos ( {ω}_{θ} t ) . \qquad ( 31 )$$

The equations (20), (21), (22) and (23) for those vectors are still valid. The new vector drawing for them is in FIG. 4. At this time, the angle between d_{Ø} and d_{θ} is a right angle. The phase angle between inlet leg and outlet angle is still ψ, but Eq. (24) becomes

$$\begin{matrix}ψ = π - 2 β = π - 2 ( \frac{π}{2} - φ ) = 2 φ , \\ and & ( 32 ) \\ \begin{matrix}ψ = 2 atan ( \frac{{d}_{ϕ}}{{d}_{θ}} ) \\ = 2 atan ( \frac{\dot{m} {W}^{2} {ω}_{θ}}{\sqrt{{{k}_{ϕ}^{2} ( 1 - \frac{{ω}_{θ}^{2}}{{ω}_{ϕ}^{2}} )}^{2} + {( {c}_{ϕ} {ω}_{θ} )}^{2}}} ) \\ \approx \frac{2 \dot{m} {W}^{2} {ω}_{θ}}{{k}_{ϕ} \sqrt{{( 1 - \frac{{ω}_{θ}^{2}}{{ω}_{ϕ}^{2}} )}^{2} + {( \frac{{c}_{ϕ} {ω}_{θ}}{{k}_{ϕ}} )}^{2}}} .\end{matrix} & ( 33 )\end{matrix}$$

From Eq. (33), we can see that to increase the sensitivity of the Coriolis sensor, we want that the W to be as large as possible; ω_{θ} to be as high as possible; k_{Ø} to be as small as possible; ω_{θ} to be as close as possible to ω_{Ø} so the term

$${( 1 - \frac{{ω}_{θ}^{2}}{{ω}_{ϕ}^{2}} )}^{2}$$

will be small and phase angle will be big. As for term

$${( \frac{{c}_{ϕ} {ω}_{θ}}{{k}_{ϕ}} )}^{2} ,$$

as c_{Ø} is very close to zero, the influence of this term is ignorable. Large ω_{θ} means that the sensing tube should have a large swing stiffness, small k_{Ø} means that the tube should a small twist stiffness. These two parameters are often interacted. For certain kind of structure, such as U-shaped tube, increasing the swing stiffness motion will also increase the twist stiffness. Once the structure is decided, the ratio is hard to change. The objective of this invention is by using a specially constructed structure to satisfy the requirements motioned above to maximize the sensor sensitivity.

### SUMMARY OF THE INVENTION

In this disclosure, a Coriolis sensor with specially bent and constructed sensing tube is disclosed. The sensing tube of the sensor consists of a measuring tube incorporated with a post. The post is inserted in the middle of the sensor sensing tube. The measuring tube can be divided as one measuring loop and two transition loops. Excitation and measuring happen in the measurement loop and transition loops bridge inlet and outlet with the measuring loop. Compare with U-shaped sensing tube with similar size, the sensor with the sensing tube of this invention has much higher ratio of swing stiffness to twist stiffness, and for this reason, the sensitivity of the sensor of this invention has a tremendous increase.

### BRIEF DESCRIPTION OF THE DRAWINGS

FIG. 1 is a sketch showing the principle of the Coriolis sensor.

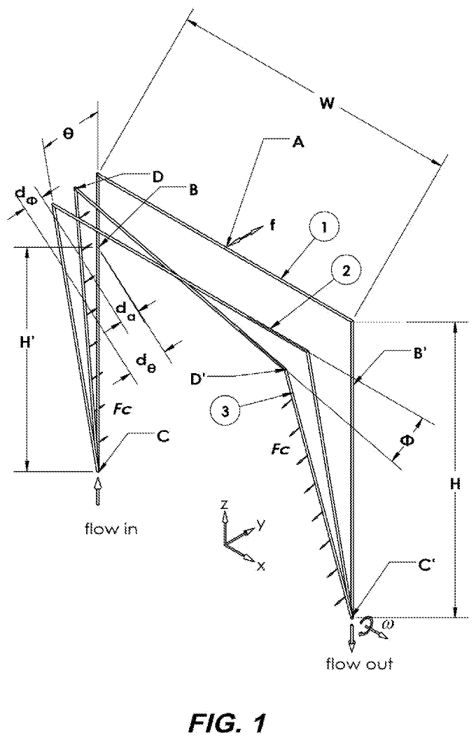

FIG. 2 is a chart showing the phase angle of the swing motion and the twist motion.

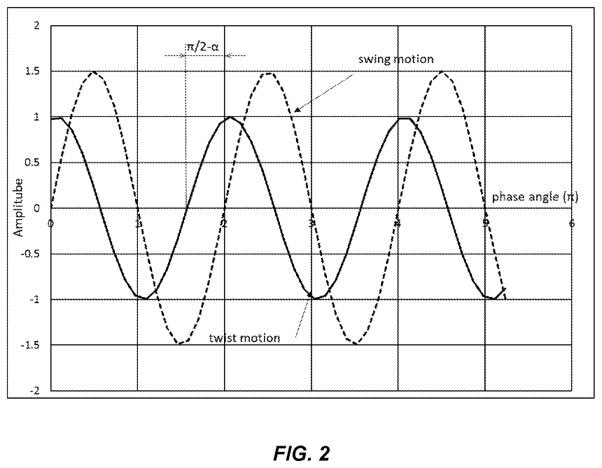

FIG. 3 is a sketch showing the relationship of the relative, reference and absolute amplitude vectors.

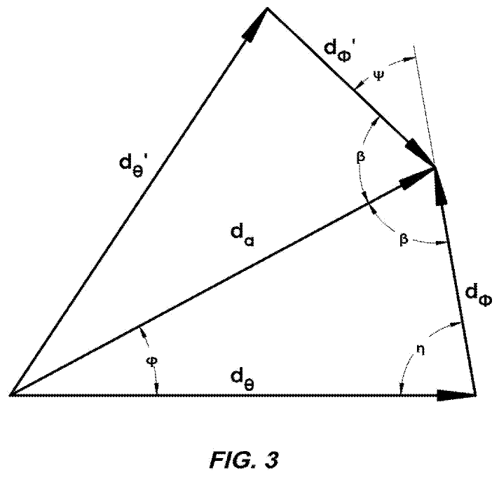

FIG. 4 is a sketch showing the relationship of the relative, reference and absolute amplitude vectors when the phase delay angle is ignored.

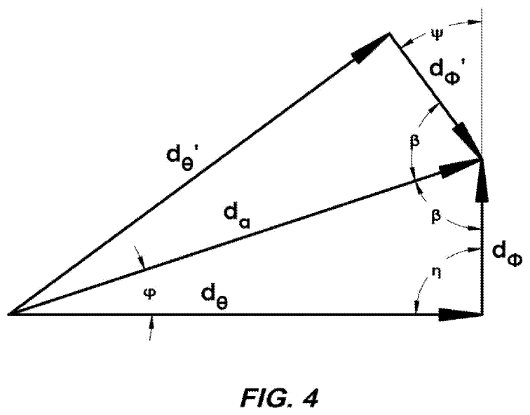

FIG. 5 is a perspective view of the mass flow sensor of this invention.

FIG. 6 is a perspective view of the sensing tube assembly.

FIGS. 7A and 7B are section views at different planes of the Coriolis sensor of this invention.

### DETAILED DESCRIPTION OF THE INVENTION

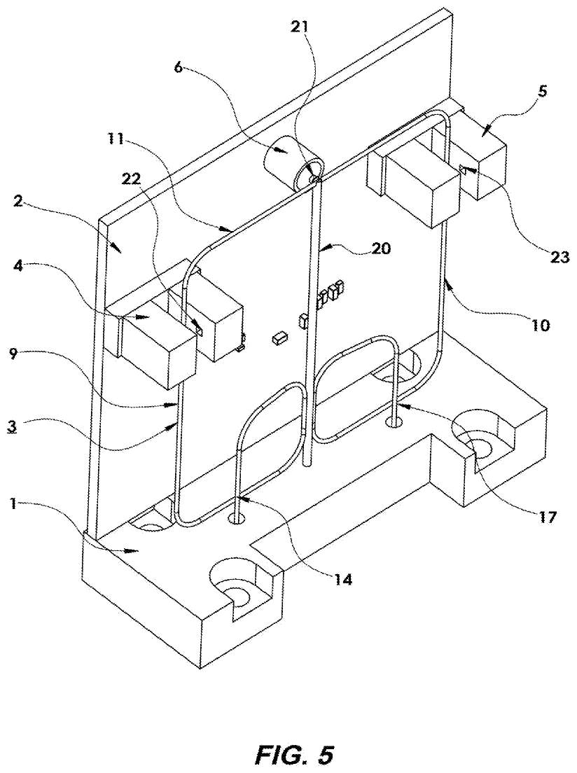

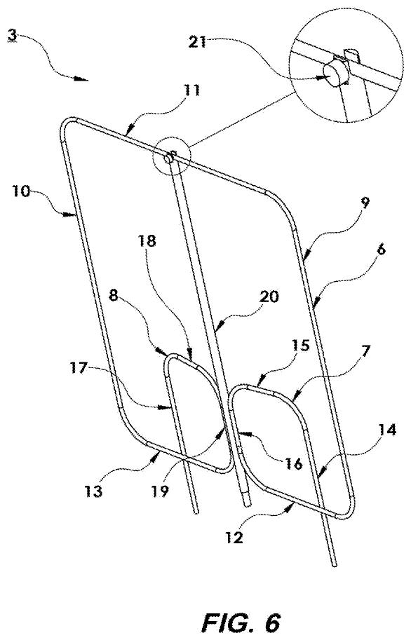

FIG. 5 is a perspective view of one of the embodiments of the Coriolis mass flow sensor of this invention. Sensor consists of sensor base 1, sensor PCB 2 and sensing tube assembly 3. Sensor base 1 has four counterbores to be used for mounting the sensor to either a flowmeter or a flow controller. It is preferred to be made of 316L. Sensor PCB 2 is mounted to base 1 from the back (not shown). On sensor PCB 2, two optical sensors 4 and 5, an excitation coil 6 are mounted. FIG. 6 is a perspective view of sensing tube assembly 3. It basically has three parts: a measuring tube, a middle post and a magnetic disk. To make the description easier, we name the measuring tube into different parts: measuring loop 6 and transition loops 7 and 8. Measuring loop 6 consists of two vertical beams 9 and 10, top horizontal transition beam 11 and bottom horizontal beams 12 and 13. Transition loop 6 consists of inlet beam 14, horizontal transition beam 15 and vertical mounting beam 16. Transition loop 7 consists of outlet beam 17, horizontal transition beam 18 and vertical mounting beam 19. Although there is no need to distinguish the difference between the inlet leg and the outlet leg for a Coriolis sensor, but if there is a thermal sensor installed in the inlet of the flowmeter or flow controller, it will make it necessary to do so. Post 20 is in the middle of sensing tube assembly 3. The lower part of post 20 are brazed together with mounting beams 16 and 19. On the top end of post 20, there is a fork shaped slot to host horizontal beam 11. There is also a flat surface on the top end of post 20 on which magnetic disk 21 is attached by adhesive. The low end of post 20 has a step. The diameter of the end part is thinner than the main body. This portion will be inserted into a bore on sensor base 1 and they will be brazed together. Sensing tube assembly 3 has two offset planes: inlet leg 14 and outlet leg 17 are located on one plane, we call it installation plane; measuring loop 6, post 20, mounting beams 16 and 19 are located on another plane, we call it measuring plane. The distance between these two parallel planes is around 2-3 mm. Transition beams 15 and 18 are crossing these two planes. Measuring tube is bent by one piece of tube. All the corners are with a fillet to facilitate the bending. The material of sensing tube assembly 3 is 316L for most of fluids and Hastelloy for some special fluids, and the ID and the OD of it are 0.406 and 0.508 mm for this embodiment, respectively. The material of post 20 is 316L or equivalent and its diameter is around 1 mm for this embodiment. The width and height of measuring loop 6 are 43.5 and 45 mm, respectively. Although increasing them will increase the sensitivity, but this is limited by the size of the sensor. The bottom ends of inlet leg 14 and outlet leg 17 will be welded or brazed airtightly to sensor base 1.

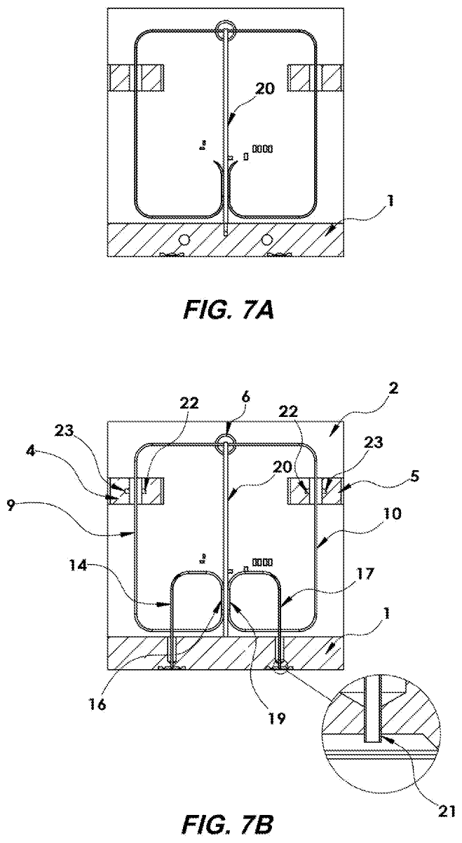

FIG. 7A and FIG. 7B are section views of the sensor. FIG. 7A is sectioned at the measuring plane and FIG. 7B is sectioned at the installation plane.

FIG. 7A shows that how post 20 is secured to sensor base 1 by brazing.

In the detail view of FIG. 7B, it can be seen that how inlet leg 14 and outlet leg 17 are secured to sensor base 1. They are laser-welded airtightly at 21. This jointing can be done with brazing if the application allows this.

The circuit will provide a sinusoidal current to excitation coil 6, which is concentrically installed with magnetic disk 21 and 1-3 mm apart, this will make sensing tube assembly 3 do a sinusoidal back and forth swing vibration. As mentioned before, to maintain a stable swing vibration, the excitation frequency of coil 6 is set as the same as the swing resonant frequency of sensing tube assembly 3, otherwise, either the power consumption is too much or the amplitude is too small to be measured.

When the sensing tube assembly 3 makes swing motion, and a fluid flows through the tube, the Coriolis force will be produced on vertical beams 9 and 10 of the measuring loop 6. There will be no Coriolis force on either top beam 11 or bottom beams 12 and 13. The Coriolis forces on vertical beam 9 and 10 change direction and magnitude periodically. These two forces will form an ever-changing torque twisting sensing tube assembly 3 periodically.

The measurement is implemented by optical sensors 4 and 5 mounted on PCB 2. The two arms of sensors 4 and 5 surround vertical beams 9 and 10 without contacting them. Light will emit from emitters 22 on the inner arms of the sensors and be received by receivers 23 on the outer arms of the sensors. The light will be partially blocked by vertical beams 9 and 10 of sensing tube assembly 3. The sensing elements of receivers 23 will output voltage signals to the circuit and they will be treated to obtain the phase angle difference between beam 9 and beam 10, and they will be in turn calibrated corresponding to the mass flow rate.

Due to the construction and supporting, the sensing tube assembly 3 has large resistance to swing motion and small resistance to twist motion. Table 1 shows some comparisons between the U-shaped tube Coriolis sensor and this invention.

TABLE 1

| | U-shaped Tube | this invention |
|---|---|---|
| Swing motion resonant | 121.63 | 243.82 |
| frequency (Hz) | | |
| Twist motion resonant | 272.20 | 297.68 |
| frequency (Hz) | | |
| ${ω}_{θ} ( \frac{rad}{sec} )$ | 763.84 | 1531.19 |
| ${ω}_{∅} ( \frac{rad}{sec} )$ | 1709.42 | 1869.43 |
| ${k}_{θ} ( \frac{N \cdot mm}{rad} )$ | 42.75 | 576.92 |
| ${k}_{∅} ( \frac{N \cdot mm}{rad} )$ | 86.38 | 90.97 |
| Phase angle difference | 0.67 | 3.08 |
| 2φ (degree) | | |

The data in Table 1 is based on 1000 [g/h] flow rate. The dimensions for the U-shaped tube: W=43.5 mm, H=54 mm; the section sizes of U-shaped tube are the same as those in this invention. We can notice that from the table that this invention has a high swing motion stiffness and a low twist motion stiffness; this is shown on the difference between k_{θ} and k_{Ø} and between ω_{θ} and ω_{Ø}. Because of these characteristics, and from Eq. (34), the phase angle difference for this invention is almost 5 times of that of the U-shaped tube.

What is claimed is:

1. A Coriolis mass flow sensor comprising:
a sensor base (1), a sensor PCB (2) and a sensing tube assembly (3).

2. The Coriolis mass flow sensor according to claim 1, wherein the sensor PCB (2) is bolted to the sensor base (1).

3. The Coriolis mass flow sensor according to claim 1, wherein the tube of sensing tube assembly (3) is formed as one integral piece which can be divided as a measuring loop (6), and two transition loops (7 and 8).

4. The sensing tube assembly (3) according to claim 3, wherein the measuring loop (6) consists of two vertical inlet beams (9 and 10), and three horizontal beams (11, 12 and 13).

5. The sensing tube assembly (3) according to claim 3, wherein the transition loop 7 consists of one vertical inlet beam (14), one vertical mounting beam (16) and one horizontal transition beam (15).

6. The sensing tube assembly (3) according to claim 3, wherein the transition loop 8 consists of one vertical outlet beam (17), one vertical mounting beam (19) and one horizontal transition beam (18).

7. The Coriolis mass flow sensor according to claim 1, wherein the sensing tube assembly (3) has a middle post (20).

8. The sensing tube assembly (3) according to claim 3, wherein the mounting beams (16, 19) are bound to the post (20) by brazing or other means.

9. The sensing tube assembly (3) according to claim 3, wherein the low end of the inlet beam (14) is fixed to the sensor base (1) airtightly by laser welding or brazing, where the fluid will flow in.

10. The sensing tube assembly (3) according to claim 3, wherein the low end of the outlet beam (14) is fixed to the sensor base (1) airtightly by laser welding or brazing, where the fluid will flow out.

11. The sensing tube assembly (3) according to claim 3, wherein the post (20) has a step at its low end, the end part is thinner than its main part, and the end part is inserted to a bore on the sensor base (1) and fixed by brazing or other means.

12. The sensing tube assembly (3) according to claim 3, wherein the post (20) has a slot at its top, in which the horizontal beam 11 is held and fixed by brazing or other means.

13. The sensing tube assembly (3) according to claim 3, wherein the post (20) has a flat surface at one side of its top, on which the permanent magnet disk (21) is attached by adhesive or other means.

14. The Coriolis mass flow sensor according to claim 1, wherein an excitation coil (6) mounted on the sensor PCB (2) will interact with the magnetic disk (21) on the sensing tube assembly (3) to make the sensing tube assembly (3) do swing vibration and produce Coriolis force.

15. The Coriolis mass flow sensor according to claim 1, wherein two optical sensors (4, 5) mounted on the sensor PCB (2) will monitor the motion of the sensing tube assembly (3).

16. The Coriolis mass flow sensor according to claim 1, wherein the circuit of the sensor PCB (2) will treat the signals obtained from the optical sensors (4, 5) to get the phase angle difference information between the beams (9 and 10), the treated signals will be calibrated to the mass flow rate of the fluid flowing through the sensor tube assembly (3).
